(19) United States
(12) Patent Application Publication
(10) Pub. No.: US 2002/0146501 A1
(43) Pub. Date: Oct. 10, 2002

(54) Flavor enhancement of beverages

(76) Inventors: Margit Doerr, Hohen-Suelzen (DE); Guido Ritter, Laer (DE); Hans-Ulrich Ter Meer, Frankfurt am Main (DE)

Correspondence Address: ProPat, L.L.C., 2912 Crosby Road, Charlotte, NC, 28211-2815, US

(21) Appl. No.: 10/050,756

(22) Filed: Jan. 16, 2002

(30) Foreign Application Priority Data
Jan. 20, 2001 (DE) 101 02 525.4

(51) Int. Cl. A23L 1/236

(52) U.S. Cl. 426/599

(57) ABSTRACT

The invention relates to beverages which comprise at least one xylooligosaccharide and at least one intense sweetener. The invention also relates to a process for producing these beverages, and to the use of xylooligosaccharides in this regard.

### BACKGROUND OF THE INVENTION

The overall impression of alcohol-free beverages is formed by aroma, sweetness impression, acidity impression and color. The quality and, in particular the flavor, of a beverage is critically influenced by the sensory interaction of the constituents. Therefore, the constituents must be carefully matched to one another in sensory activity.

If, for example, the ratio of sweetness and acidity is unbalanced in a beverage, then the beverage has an inharmonious taste. Not only intense sweetness which is not balanced by acidity, but also excessive acidity with low sweetness are perceived as pronounced quality defects.

An unbalanced sweetness-acidity ratio may be partially, but usually not satisfactorily, however, compensated by other constituents. The use of flavorings, sometimes even at elevated concentrations, is also unsuitable for this. In contrast, in the manufacture of a beverage, the levels of sweeteners and acidulants must be carefully matched to the flavorings used, since otherwise individual flavoring components can be undesirably emphasized or attenuated. In the sector of customary formulas sweetened with different types of sugar, sugar (sucrose) in pure or partially inverted form, or glucose-fructose syrups have an important role beyond their function as sweetener. They cause a full-bodied flavor impression and as a result allow many flavorings to appear well and in a balanced manner.

Owing to the differing sensory properties of the constituents, it is not simple to develop a beverage harmonious in taste. This applies in particular if, instead of the usual sugar (sucrose), or glucose-fructose syrups, intense sweeteners are to be used.

Intense sweeteners are known not to achieve the taste profile of sugar when they are used as individual components. It has long been found that mixtures of intense sweeteners can lead to a better sweet taste than individual sweeteners. Such sweetener mixtures for beverages are, for example, the previously frequently used combination of saccharin and cyclamate in the ratio of 1:10, or the mixture with an improved taste which is now widespread of acesulfame-K and aspartame in roughly equal proportions. The taste profile, that is to say the time course of the perception of sweetness, in the case of the latter mixture, is already relatively similar to sugar, however, the important full-bodied character, which describes the taste harmony of aroma, sweetness and acidity, and not only relates to full mouth feel, is frequently lacking, in particular in beverages which are exclusively sweetened with intense sweeteners, but also in reduced-sugar beverages additionally comprising intense sweeteners. This full-bodied character is essential for a particularly harmonious flavor impression.

Even if the taste quality of beverages containing intense sweeteners has been able to be markedly increased already by the availability of novel sweeteners having improved properties, there is, however, still the problem of the absence of full-bodied character with these beverages.

Attempts have already been made in various ways, by means of various components which were added to a beverage, to achieve the full-bodied character of a beverage. To improve the mouthfeel by increasing viscosity, and to enhance the taste with respect to sweetness of beverages sweetened with sweeteners, certain oligosaccharides, for example fructooligosaccharides or galactooligosaccharides, have been proposed. (See DE 196 53 354). Fructooligosaccharides are, for example, inulin and oligofructose. Owing to their digestive properties, they are added to various foods, in particular milk products. However, in order to achieve any activity in beverages in the desired area, that is to say full-bodied character, considerable amounts of these oligosaccharides must be added to the beverage, frequently up to 10% by weight. This gives rise to considerable costs, which can be above those of conventional sweetening using sugar or glucose-fructose syrups. Since they must be added in large amounts, the digestive action, for which reasons they are used in other foods, is also correspondingly expected in beverages. Since beverages are consumed in greater amounts than such foods, possibly greater, generally unwanted, effects may occur. Other flavor-modifying substances which have been proposed to increase the full-bodied character of beverages, for example maltol, also do not show the desired effects, or are only compatible with certain flavors.

### SUMMARY IF THE INVENTION

There is therefore still a requirement for ingredients suitable for beverages which can be used without problem, using which the full-bodied character of beverages can be increased, and thus the flavor quality can be enhanced.

It has now been found that xylooligosaccharides contribute to the full-bodied character of beverages. Surprisingly, xylooligosaccharides can, even at relatively small doses, significantly improve the full-bodied character of beverages containing intense sweeteners, and can thus significantly enhance the overall flavor impression.

The invention accordingly relates to a beverage which comprises xylooligosaccharide and at least one intensive sweetener.

For the purposes of the invention, “beverages” is taken to mean in particular (alcohol-free), water-based soft drinks, for example lemonades or those based on milk or fermented milk or those based on malt or other carbohydrate-containing raw materials. These beverages can also comprise carbon dioxide.

### DETAILED DESCRIPTION OF THE INVENTION

The xylooligosaccharides used in the inventive beverages are preferably compounds of the formula I.

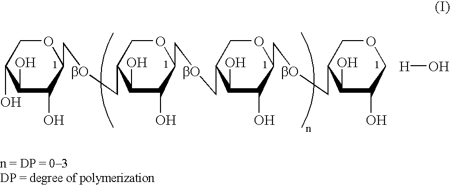

Particular preference is given to xylooligosaccharides having a degree of polymerization of DP=1 to 10, preferably DP=2 to 5, very particularly preferably DP=2 to DP=3, and mixtures of xylooligosaccharides having differing degrees of polymerization. The inventive xylooligosaccharides can be prepared, for example, by enzymatic hydrolysis of xylan, for example from corncobs and cotton seed. They chiefly consist of xylobiose (formula I, n=0) and xylotriose (formula I, n=1) and have about one quarter the sweetening power of sucrose, that is to say only low sweetness. They are usable as powder and as syrup (for example containing 70% dry matter).

The xylooligosaccharides are added to the inventive beverages expediently in amounts of 0.01-5.00% by weight, in particular 0.1-2.0% by weight, preferably 0.6-0.9% by weight (based on pure (100% pure) xylooligosaccharide per unit weight of beverage). Surprisingly, xylooligosaccharides have the inventive action especially in relatively low concentrations. If they are used at higher concentrations, as would be necessary, for example, in the case of fructooligosaccharides, no further flavor enhancement occurs, or else they change the sweetness intensity and/or the sweetness profile of the beverage, so that the beverage can even be impaired overall.

The xylooligosaccharides are added to the beverages in a conventional manner, for example by addition during beverage manufacture or by addition to a beverage constituent.

Xylooligosaccharides increase the full-bodied character of the beverages markedly, so that a product results whose flavor is in excellent harmony with respect to aroma, sweetness and acidity, and is sugar-like.

‘Intense sweeteners’, for the purposes of the invention, is taken to mean, for example, acesulfame, alitame, aspartame, cyclamate, neohesperidin dihydrochalcone, neotame, saccharin, sucralose and thaumatin or their water-soluble sodium salts, potassium salts and calcium salts, and mixtures of two or more of these intense sweeteners.

The inventive beverages can also be based on natural fruit juices or their concentrates, but also on flavorings, essences and extracts.

If expedient, the xylooligosaccharides, to produce reduced-sugar beverages, can also be used in combination with sugar (sucrose), glucose or fructose, in solid or syrup form.

The invention is described in more detail below with reference to examples:

### EXAMPLES

Xylooligosaccharides (XOS) were added to a carbonated alcohol-free soft drink containing cola flavoring (Cola base No. 6030 or 340415, from Dohler, Darmstadt, Germany) and subjected to sensory testing. The product called XOS 95 P is a pulverulent oligosaccharide mixture comprising at least 95% by weight of xylooligosaccharide (ₙXylo-oligo 95 P″, Suntory Limited, Tokyo, Japan). The product XOS 70 S is a xylooligosaccharide syrup of 70% dry matter (ₙXylo-oligo 70″, Suntory Limited, Tokyo, Japan) comprising at least 70% by weight of XOS. They were used in concentrations of 0.75% by weight (pulverulent product) or 1% by weight (syrup, equivalent to approximately 0.7% dry matter).

Percentages by weight are based on the entire beverage formula.

The beverage was sweetened using internationally typical levels of sweeteners, or, in the base of mixtures, internationally typical levels and ratios

1. using a combination of the sweeteners acesulfame-K (Sunett, Nutrinova, Frankfurt, Germany) and aspartame (aspartame, Holland Sweetener Company, Netherlands)

2. using an equally sweet concentration of aspartame as an individual sweetener.

The table below shows the results of sensory testing of these beverages.

| | | | Cola with 0.75% XOS | | Cola with 1% XOS | |
|---|---|---|---|---|---|---|
| | | | powder | | syrup | |
| | Control | | Example 1 | | Example 2 | |
| Cola-base | 5 | g | 5 | g | 5 | g |
| 6030 | | | | | | |
| XOS 95 P | — | | 7.5 | g | — | |
| XOS 70 S | — | | — | | 10.0 | g |
| Acesulfame-K | 0.130 | g | 0.130 | g | 0.130 | g |
| Aspartame | 0.305 | g | 0.305 | g | 0.305 | g |
| CO₂ | 5 | g | 5 | g | 5 | g |
| Water | to 1 | l | to 1 | l | to 1 | l |
| Sensory | | | | | | |
| evaluation | | | | | | |
| | pleasant | | sweetness-acidity ratio | | sweetness profile | |
| | sweetness, | | more balanced, more | | better than in the | |
| | pleasant aroma, | | harmonious flavor than | | control, very similar to | |
| | acidity markedly | | control | | sugar, more | |
| | perceptible | | | | harmonious and fuller | |
| | | | | | flavor than control | |
| | | | Cola with 0.75% XOS | | Cola with 1% XOS | |
| | | | powder | | syrup | |
| | Control | | Example 3 | | Example 4 | |
| Cola-base | 5.5 | g | 5.5 | g | 5.5 | g |
| 340415 | | | | | | |
| XOS 95 P | — | | 7.5 | g | — | |
| XOS 70 S | — | | — | | 10.0 | g |
| Acesulfame-K | 0.130 | g | — | | — | |
| Aspartame | 0.305 | g | 0.850 | g | 0.850 | g |
| CO₂ | 5 | g | 5 | g | 5 | g |
| Water | to 1 | l | to 1 | l | to 1 | l |
| Sensory | | | | | | |
| evaluation | | | | | | |

| | | |
|---|---|---|
| pleasant sweetness, | sweetness-acidity ratio | rounder and more |
| pleasant aroma, | balanced, more | harmonious flavor than |
| acidity markedly | harmonious, rounder and | control, very good |
| perceptible | fresher flavor than | mouthfeel |
| | control | |

The results verify that xylooligosaccharides, even at low concentrations, give enhanced all-bodied character and more rounded flavor in beverages containing intense sweeteners, than in commercial formulations without XOS.

On the other hand, the addition of a greater amount of XOS leads to no further preference. The example below shows a paired comparison between a cola beverage containing 0.75% and 5% XOS.

| | Cola with | Cola with |
|---|---|---|
| | 0.75% XOS powder | 5% XOS powder |
| | Example A | Example B |
| Cola base | 5 g | 5 g |
| XOS 95 P | 7.5 g | 50 g |
| Acesulfame-K | 0.130 g | 0.130 g |
| Aspartame | 0.305 g | 0.305 g |
| CO₂ | 5 g | 5 g |
| Water | to 1 l | to 1 l |

Sensory test: duotest (direct comparison between the two XOS formulas)

| | | |
|---|---|---|
| Which sample is sweeter? | not significant | not significant |
| Which sample has better flavor? | not significant | not significant |
| Which sample is more like sugar? | not significant | not significant |

The example below shows that a different oligosaccharide (fructooligosaccharide; FOS) typically used at low concentrations but, at 2%, somewhat increased in comparison with the low concentrations of the XOS used, has no effect, or even a disadvantageous effect on the mouthfeel and perception of sweetness. In this case, solutions of sweetener mixtures in water with or without the addition of FOS were tested in descriptive sensory analysis (size of the group N=20). As an index, a ten-point scale was used (0: very low; early, to 10=very intense; very late).

| | | Sweetness | |
|---|---|---|---|
| Sample | Body | duration | Drying |
| 140 ppm Acesulfame-K + | 5.3 | 4.8 | 0.2 |
| 140 ppm aspartame | | | |
| 140 ppm Acesulfame-K + | 4.2 | 4.0 | 0.8 |
| 140 ppm Aspartame + 2% | | | |
| FOS | | | |
| 7.7% Sucrose + 2% FOS | 5.0 | 4.5 | 0.0 |

The examples below show the effect of higher concentrations of xylooligosaccharides:

| | | Drinking yogurt | Drinking yogurt |
|---|---|---|---|
| | | containing 5.0% | containing |
| | | XOS powder | 5.0% XOS syrup |
| | Control | Example 5 | Example 6 |
| Whey | 300 g | 300 g | 300 g |
| Multivitamin juice | 100 g | 100 g | 100 g |
| (“Valensina”, Germany) | | | |
| Sugar | 85 g | — | — |
| Acesulfame-K | — | 0.09 g | 0.09 g |
| Aspartame | — | 0.09 g | 0.09 g |
| XOS 95 P | — | 50 g | — |
| XOS 70 S | — | — | 50 g |
| Commercial natural | to | to | for producing |
| yogurt (1.5% fat) | 1000 g | 1000 g | beverages to |
| | | | 1000 g |

Sensory test: duo test (direct comparison of
the two XOS formulas with the control)

| | | |
|---|---|---|
| Which sample is sweeter? | not significant | not significant |
| Which sample has better taste? | not significant | not significant |
| Which sample is more like sugar? | not significant | not significant |

It is clear that neither a product containing 5% XOS powder nor 5% XOS syrup is preferred to the control with respect to flavor or resemblance to sugar.

What is claimed is:

1. A beverage which comprises at least one xylooligosaccharide and at least one intense sweetener.

2. The beverage as claimed in claim 1, wherein the xylooligosaccharide is a compound of the formula I

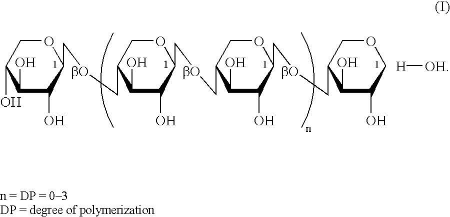

3. The beverage as claimed in claim 1, wherein the xylooligosaccharide has a degree of polymerization of DP=1 to 10.

4. The beverage as claimed in claim 1, wherein the beverage comprises 0.01 to 5% by weight (based on the beverage) of xylooligosaccharide.

5. The beverage as claimed in claim 1, wherein the intense sweetener is selected from the group consisting of: acesulfame, alitame, aspartame, cyclamate, neohesperidin dihydrochalcone, neotame, saccharin, sucralose, thaumatin, water-soluble sodium salts, potassium salts, calcium salts of these intense sweeteners and mixtures of two or more members of this group.

6. The beverage as claimed in claim 1, based on water, milk or fermented milk, flavorings, essences, extracts of fruits or fruit juices, or extracts of malt or other carbohydrate-containing raw materials.

7. The beverage as claimed in claim 1, wherein it also comprises sugar (sucrose), glucose and/or fructose in solid or syrup form.

8. The beverage as claimed in claim 5, wherein the intense sweetener is a mixture of Acesulfame-K (=potassium salt of acesulfame) and aspartame.

9. The beverage as claimed in claim 1, wherein it contains carbon dioxide.

10. A process for producing a beverage as claimed in claim 1, which comprises adding to a beverage at least one xylooligosaccharide and at least one intense sweetener.

11. A method for producing beverages by using xylooligosaccharides as an intense sweetner.
